(19) United States
(12) Patent Application Publication
(10) Pub. No.: US 2025/0273656 A1
(43) Pub. Date: Aug. 28, 2025

(54) MULTILAYER CORE-SHELL STRUCTURE, METHOD FOR PRODUCING THE SAME, AND CATHODE ACTIVE MATERIAL FOR LITHIUM-SULFUR CELL INCLUDING THE SAME

(71) Applicant: SEOUL NATIONAL UNIVERSITY R&DB FOUNDATION, Seoul (KR)

(72) Inventors: Dong Yoon PARK, Seoul (KR); Chong Rae PARK, Seoul (KR); Jae Ho KIM, Busan (KR)

(73) Assignee: SEOUL NATIONAL UNIVERSITY R&DB FOUNDATION, Seoul (KR)

(21) Appl. No.: 18/742,334

(22) Filed: Jun. 13, 2024

(30) Foreign Application Priority Data
Feb. 23, 2024 (KR) 10-2024-0026463

(51) Int. Cl. H01M 4/36; H01M 4/02; H01M 4/38; H01M 4/62

(52) U.S. Cl. CPC H01M 4/366; H01M 4/38; H01M 4/62; H01M 2004/028

(57) ABSTRACT

The present disclosure relates to a multilayer core-shell structure, a method for producing the same, and a cathode active material for a lithium-sulfur cell including the same. More specifically, the present disclosure provides a multilayer core-shell structure that has reduced defects in the shell and is capable of stably maintaining its structure, and a cathode active material for a lithium-sulfur cell, which is capable of providing a lithium-sulfur cell having excellent rate capability and excellent cycle life characteristics such as long-term stability.

### CROSS-REFERENCE TO RELATED PATENT APPLICATIONS

This application claims the benefit of Korean Patent Application No. 10-2024-0026463, filed on Feb. 23, 2024, in the Korean Intellectual Property Office, the disclosures of which are incorporated herein in their entireties by reference.

### TECHNICAL FIELD

The present disclosure relates to a multilayer core-shell structure, a method for producing the same, and a cathode (positive electrode) active material for a lithium-sulfur cell including the same.

### BACKGROUND

A core-shell structure is a structure composed of a central core and a shell surrounding the same, and various combinations of different materials forming the core and the shell are possible. The core-shell structure is used in various applications, including drug delivery materials, materials for biomolecular analysis such as magnetic nanoparticles or fluorescent nanoparticles, electrochemical catalyst materials, and electrode active materials, depending on the combination of materials that form the core and the shell. In general, such a core-shell structure is a structure including a core having a function suitable for the intended use and a shell that can protect the core or confer additional functions.

However, when the material forming the shell is based on an organic polymer, problems arise in that the shell layer undergoes volume changes with external temperature changes due to the lower critical solution temperature (LCST) and upper critical solution temperature (UCST) behaviors of the organic polymer, and in that a number of defects exist in the shell layer.

Meanwhile, with the rapid growth of the electric vehicle and energy storage system (ESS) fields, as well as the growing demand for improved performance of cells that are used therein, lithium-sulfur cells are considered as one of the most notable next-generation cells. When sulfur is used as a cathode material, it has the advantage of much lower material costs than metal oxides, and thus the applicability and marketability of the lithium-sulfur cells are increasing. However, lithium-sulfur cells have difficulties in commercialization because fundamental problems, including the slow rate of the sulfur conversion reaction, poor reversibility, large volume change, and the shuttle effect of polysulfide, have not yet been resolved. In particular, the shuttle effect of polysulfide refers to a phenomenon in which polysulfide (Li₂Sₓ, (4≤×≤8)) formed during the discharging of a lithium-sulfur cell is dissolved in an organic electrolyte solution and moves from the cathode to the anode (negative electrode). Due to this phenomenon, a problem arises in that the polysulfide that moved to the anode reacts with Li, causing loss of the cathode active material, which results in a rapid decrease in cell capacity.

Accordingly, attempts to solve the problems of the lithium-sulfur cell have been made in various ways, and among various strategies, there has also been research on the strategy of confining the active material to a core-shell structure. However, because previously reported active materials with a core-shell structure mainly had a single shell layer including a single polymer, there were a number of defects in the shell, and these active materials could not satisfy a high sulfur content and stability against large volume changes, which are required for commercialization of lithium-sulfur cells.

### SUMMARY

A first object to be achieved by the present disclosure is to provide a multilayer core-shell structure that has reduced defects in the shell and is capable of stably maintaining its structure.

A second object to be achieved by the present disclosure is to provide a cathode active material for a lithium-sulfur cell, which is capable of providing a lithium-sulfur cell having improved capacity and significantly improved cycle life characteristics.

However, objects to be solved by the present disclosure are not limited to the above-mentioned objects, and other problems not mentioned above will be clearly understood by those skilled in the art from the following description.

One embodiment of the present disclosure provides a multilayer core-shell structure including: a core; a first shell surrounding the core and including an organic linker, which includes a multifunctional organic compound, and a first polymer; and a second shell surrounding the first shell and including a second polymer, wherein the first polymer and the organic linker form a network by non-covalent interaction therebetween.

Another embodiment of the present disclosure provides a cathode active material for a lithium-sulfur cell including the multilayer core-shell structure according to one embodiment of the present disclosure, wherein the core contains sulfur, and the second polymer includes a conductive polymer.

Still another embodiment of the present disclosure provides a method for producing the multilayer core-shell structure according to one embodiment of the present disclosure, the method including steps of: mixing solution containing a first polymer and a solution containing an organic linker comprising a multifunctional a organic compound to obtain a solution having dispersed therein a network structure formed by non-covalent interaction between the first polymer and the organic linker; adding a material for core growth to the solution having dispersed therein the network structure to obtain a core-first shell intermediate; and forming a second shell including a second polymer by adding a monomer for the second polymer to the solution containing the core-first shell intermediate, followed by reaction.

The multilayer core-shell structure according to one embodiment of the present disclosure may be thermally stable due to its volume change with temperature change.

The multilayer core-shell structure according to one embodiment of the present disclosure is capable of firmly maintaining its shape without being collapsed even by volume changes caused by the inflow of materials.

The cathode active material for a lithium-sulfur cell according to one embodiment of the present disclosure is capable of improving the cycle life characteristics of a lithium-sulfur cell by preventing the shuttle effect of polysulfide.

The cathode active material for a lithium-sulfur cell according to one embodiment of the present disclosure may have a high content of sulfur, thereby improving the rate capability and capacity of a lithium-sulfur cell.

The lithium-sulfur cell according to one embodiment of the present disclosure may have excellent rate capability and excellent cycle life characteristics such as long-term stability.

The method for producing a cathode active material for a lithium-sulfur cell according to one embodiment of the present disclosure may be cost-effective because it uses a simple production process and does not require complicated production equipment.

Effects of the present disclosure are not limited to the effects described above, and effects not mentioned above may be clearly understood by those skilled in the art from the present specification and the accompanying drawings.

### BRIEF DESCRIPTION OF THE DRAWINGS

FIG. 1 schematically shows a multilayer core-shell structure according to one embodiment of the present disclosure, which is used as a cathode active material for a lithium-sulfur cell.

FIG. 2 shows SEM images of S@PVP (a) produced in Comparative Example 1, and S@PT (b), S@PTF (c), and

S@PTF/PPy (d) obtained in Example 1.

FIG. 3A shows the results of TEM line scan analysis for S@PTF/PPy produced in Example 1.

FIG. 3B shows the average radius of each of the sulfur core included in S@PTF/PPy produced in Example 1, SOPT, S@PTF, and S@PTF/PPy.

FIG. 4 shows the TGA curve and sulfur content measured for each of S@PT, S@PTF, and S@PTF/PPy obtained in Example 1.

FIG. 5 shows the Raman spectra of S@PT, S@PTF, and S@PTF/PPy obtained in Example 1.

FIG. 6 shows SEM images of S@PTF and S@PTF/PPy, obtained in Example 1, before and after dispersion in an electrolyte, and photographs of the electrolyte solution.

FIGS. 7A and 7B show photographs of lithium-sulfur beaker cells of Comparative Example 2 and Example 2-1, respectively, taken after discharging.

FIG. 7C shows the UV-Vis absorption spectra of an electrolyte and a reference solution (Li₂S₈) after discharging the lithium-sulfur beaker cells of Comparative Example 2 and Example 2-1.

FIG. 8A shows the charge and discharge voltage profiles of the lithium-sulfur beaker cell of Example 2-1.

FIG. 8B shows SEM images of S@PTF/PPy at the discharge end point (D2) and charge end point (C2) of the lithium-sulfur beaker cell of Example 2-1.

FIG. 8C shows S@PTF/PPy particle diameter distributions at discharge points (D1 and D2), charge points (C1 and C2), and start point (P), measured for the lithium-sulfur beaker cell of Example 2-1.

FIG. 8D shows the Raman spectra of S@PTF/PPy at discharge points (D1 and D2), charge points (C1 and C2), and start point (P), measured for the lithium-sulfur beaker cell of Example 2-1.

FIG. 9A shows CV curves of the cell of Example 3-1 at a scan rate of 0.1 to 1 mV·s⁻¹.

FIG. 9B shows the diffusion coefficients of lithium ions, calculated from peaks I, II, and III for the cells of Examples 3-1 to 3-4 and Comparative Example 3.

FIG. 9C shows CV curves obtained by reassembling the cells of Example 3-1, Example 3-3, and Example 3-4 into symmetric cells.

FIGS. 9D and 9E respectively show the current-time transient spectra and potentiostatic discharge test results for the cells of Example 3-1, Example 3-3, and Example 3-4.

FIG. 9F schematically shows the electrodeposition behavior of LizS.

FIGS. 10A and 10B respectively show the rate capability and coulombic efficiency versus cycle number of the cells of Example 3-1, Example 3-4, and Comparative Example 3.

FIGS. 10C and 10D respectively show the polarization and Q2/Q1 ratio of the cells of Example 3-1, Example 3-4, and Comparative Example 3.

FIG. 11A shows the specific capacity of the cell of Example 3-1 for 500 cycles at 3 C and 5 C.

FIG. 11B shows the Raman spectra of an electrode including S@PTF/PPy and an electrode including a KB-S composite after 500 cycles of charge and discharge at 3 C for the cells of Example 3-1 and Comparative Example 3.

FIG. 11C shows SEM images of S@PTF/PPy after 500 cycles of charge and discharge at 3 C for the cell of Example 3-1.

### DETAILED DESCRIPTION

Throughout the present specification, it is to be understood that when any part is referred to as “including” any component, it does not exclude other components, but may further include other components, unless otherwise specified.

Throughout the present specification, when any member is referred to as being “on” another member, it not only refers to a case where any member is in contact with another member, but also a case where a third member exists between the two members.

Throughout the present specification, “A and/or B” refers to “A and B”, A, or B.

Throughout the present specification, the term

“defect” may mean a portion or empty space where the distribution of atoms or molecules on the surface of a material is not uniform.

Hereinafter, the present disclosure will be described in more detail.

<Multilayer Core-Shell Structure>

One embodiment of the present disclosure provides a multilayer core-shell structure including: a core; a first shell surrounding the core and including an organic linker, which includes a multifunctional organic compound, and a first polymer; and a second shell surrounding the first shell and including a second polymer, wherein the first polymer and the organic linker form a network by non-covalent interaction therebetween.

The multilayer core-shell structure according to one embodiment of the present disclosure may be a spherical particle having a diameter of nanometers to micrometers.

In the multilayer core-shell structure according to one embodiment of the present disclosure, the first polymer and the organic linker form a network by non-covalent interaction therebetween, and thus defects included in the first shell may be reduced, thereby improving the stability of the multilayer core-shell structure. The multilayer core-shell structure according to one embodiment of the present disclosure may be thermally stable due to its small volume change with temperature change, and is capable of firmly maintaining its shape without being collapsed even by volume changes caused by the inflow of materials.

According to one embodiment of the present disclosure, the first shell may be a supramolecular structure which is a network formed by non-covalent interaction between the first polymer and the organic linker, and thus a single-atom catalyst that coordinates with the organic linker may be additionally introduced into the first shell.

According to one embodiment of the present disclosure, the non-covalent interaction may be at least one selected from the group consisting of interactions based on hydrogen bonding, van der Waals force, ionic bonding, dipole-dipole interaction, pi-pi interaction, cation-pi interaction, and halogen bonding.

Preferably, the non-covalent interaction may include hydrogen bonding. When the non-covalent interaction includes hydrogen bonding, the strength of the non-covalent interaction increases, and thus defects included in the first shell may be further reduced and the stability of the core-shell structure may be improved.

According to one embodiment of the present disclosure, the multifunctional organic compound may contain at least one functional group selected from the group consisting of imide, u amide, carbonyl, carboxy, hydroxy, ether, azoxy, oxadiazole, thiol, thioether, thiourea, thiadiazole, sulfonate, nitro, amine, imine, azine, pyridine, pyrazine, pyrimidine, pyridazine, triazine, tetrazine, pyrazole, imidazole, triazole, tetrazole, phosphate, and halogen.

According to one embodiment of the present disclosure, the multifunctional organic compound may contain 2 or more, 3 or more, 4 or more, 5 or more, or 10 or more functional groups described above. According to one embodiment of the present disclosure, the multifunctional organic compound may contain 5,000 or less, 1,000 or less, 500 or less, or 100 or less functional groups described above. However, in the present disclosure, the upper limit of the number of functional groups contained in the multifunctional organic compound is not particularly limited. As the multifunctional organic compound contains a larger number of functional groups, a stronger network may be formed by non-covalent interaction between the organic linker and the first polymer.

Examples of the multifunctional organic compound include polycarboxylic acid compounds such as benzenetricarboxylic acid and benzenetriacetic acid;

polysulfonic acid compounds such as 1,3-benzenedisulfonic acid; polyamine compounds such as diamino triazine, hexaaminobenzene, and hexaaminotriphenylene; polythiol compounds such as benzenehexathiol and alcohol compounds triphenylenehexathiol; and polyhydric such as polyphenols.

Preferably, the multifunctional organic compound may include a polyhydric alcohol compound such as a polyphenol.

More specifically, the polyphenol may be at least one selected from the group consisting of tannic acid, isoflavone, catechin, curcumin, hydroxybenzoic acid, hydroxycinnamic acid, flavonoid, lignan, stilbene, caffeic acid, chlorogenic acid, anthocyanin, pyrogallol, ellagic acid, garlic acid, theaflavin-3-gallate, resveratrol, kaempferol, quercetin, myricetin, luteolin, delphinidin, cyanidin, ampelopsin, hesperidin, aurantinidin, europinidin, pelargonidin, malvidin, peonidin, petunidin, rosinidin, and derivatives thereof.

As the multifunctional organic compound includes a polyhydric alcohol compound such as polyphenol, it may form a strong network via hydrogen bonding with the first polymer.

According to one embodiment of the present disclosure, the first polymer may be a polymer compound containing at least one functional group selected from the group consisting of imide, urea, amide, carbonyl, carboxy, hydroxy, ether, azoxy, oxadiazole, thiol, thioether, thiourea, thiadiazole, sulfonate, nitro, amine, imine, azine, pyridine, pyrazine, pyrimidine, pyridazine, triazine, tetrazine, pyrazole, imidazole, triazole, tetrazole, phosphate, and halogen.

Specifically, the first polymer may be any one or more selected from the group consisting of polyvinylpyrrolidone (PVP), polyvinylalcohol (PVA), polyethylene oxide (PEO), polystyrene (PS), polyethylene glycol (PEG), polyacrylic acid (PAA), polyacrylamide (PAM), polymetacrylate (PMA), polymethylmethacrylate (PMMA), polyimide (PI), polyacrylate (PAE), and copolymers thereof. As the first polymer is any one or more selected from among those described above, it may form a network via non-covalent interaction with the organic linker.

According to one embodiment of the present disclosure, the first shell may further include a single-atom catalyst that coordinates with the organic linker. As the first shell further includes a single-atom catalyst, the electrochemical catalytic performance of the multilayer core-shell structure may be improved.

According to one embodiment of the present disclosure, the single-atom catalyst may include at least one selected from the group consisting of Be, B, Mg, Al, Si, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, Lu, Ac, Th, U, Np, Pu, Am, and Cm.

The core-shell structure according to one embodiment of the present disclosure may be designed to be used in various applications, including electrode active materials, drug delivery systems, materials for in vivo imaging and diagnosis, nanosensors, and nanocatalysts, by adjusting the types of materials forming the core and the first shell and the second shell.

Specifically, the core may include a functional material that enables the core-shell structure to be used in the intended application, and the first and second shells may include a material that can either provide stability to protect the core or confer additional functions.

According to one embodiment of the present disclosure, the core may include a cathode (positive electrode) active material, an anode (negative electrode) active material, a drug, a semiconductor, a catalyst material, or a magnetic particle.

According to one embodiment of the present disclosure, the second polymer may include a conductive polymer, a fluorescent polymer, a self-healing polymer, a biocompatible polymer, or a shape memory polymer.

<Cathode Active Material for Lithium-Sulfur Cell>

Another embodiment of the present disclosure provides a cathode active material for a lithium-sulfur cell including the multilayer core-shell structure according to one embodiment of the present disclosure, wherein the core contains sulfur, and the second polymer includes a conductive polymer.

The cathode active material for a lithium-sulfur cell according to one embodiment of the present disclosure may prevent the shuttle effect of polysulfide and have a high content of sulfur, thereby improving the rate capability, long-term stability, and capacity of a lithium-sulfur cell.

In the cathode active material according to one embodiment of the present disclosure, the second shell surrounding the first shell serves to protect the structure of the core and the first shell. As the cathode active material according to the present disclosure includes the second shell surrounding the first shell and including a conductive polymer, it may keep the multilayer core-shell structure from large volume changes caused by charging and discharging of the lithium-sulfur cell, resulting in significant improvement in the cycle life characteristics of the cell compared to those of existing core-shell-based cathode active materials.

In the cathode active material for a lithium-sulfur cell according to the present disclosure, the second shell surrounding the first shell and including a conductive polymer serves to protect the structures of the core and the first shell and at the same time, improve electrochemical performance. Specifically, as the cathode active material according to the present disclosure includes the second shell, it may keep the multilayer core-shell structure from large volume changes caused by charging and discharging of the lithium-sulfur cell, resulting in significant improvement in the cycle life characteristics of the cell compared to those of existing core-shell-based cathode materials, and may have improved electrochemical performance, which may improve the capacity of a lithium-sulfur cell including the same.

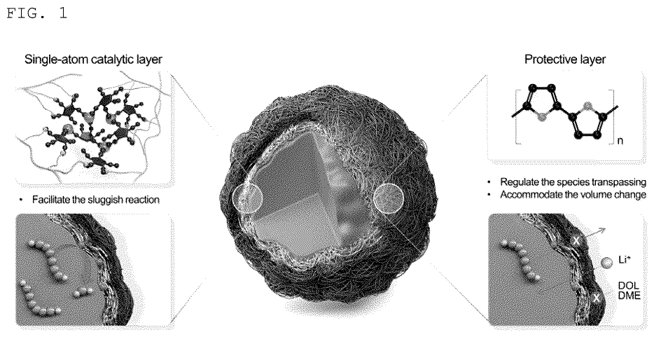

FIG. 1 schematically shows a multilayer core-shell structure according to one embodiment of the present disclosure, which is used as a cathode active material for a lithium-sulfur cell. Referring to FIG. 1, it can be seen that the multilayer core-shell structure according to one embodiment of the present disclosure, which is used as a cathode active material for a lithium-sulfur cell, has a multilayer core-shell structure including: a core containing sulfur; a first shell surrounding the core; and a second shell surrounding the first shell. According to the present disclosure, the multi-layered shell including the first shell and the second shell is permeable to lithium ions (Lit), but is impermeable to an electrolyte (DOL/DME) and polysulfide, and thus may have an excellent electrocatalytic effect and provide a cathode active material for a lithium-sulfur cell, which has excellent rate capability and cycle life characteristics.

According to an exemplary embodiment of the present disclosure, the first shell is a supramolecular structure which is a network formed by non-covalent interaction between the first polymer and the organic linker, and thus defects included in the first shell may be minimized so that lithium polysulfide (LiPSs) the generated by conversion of sulfur does not pass through the first shell, thereby effectively preventing lithium polysulfide and/or sulfur from being lost to the outside of the core-shell structure.

According to one embodiment of the present disclosure, the first shell contains a large amount of functional groups, which can provide additional binding sites, and thus a lithium-sulfur cell including the cathode active material according present disclosure has high capacity even at a high rate.

According to one embodiment of the present disclosure, the first shell adjacent to the core may further include a single-atom catalyst, which may improve the electrocatalytic performance of the cathode active material for a lithium-sulfur cell. Specifically, the first shell may further include a single-atom catalyst on the outer surface thereof, thereby lowering the energy barrier for the sulfur conversion reaction and promoting charge transfer to lithium polysulfide.

In the cathode active material for a lithium-sulfur cell according to one embodiment of the present disclosure, the single-atom catalyst preferably includes a transition metal. More preferably, the single-atom catalyst may include iron (Fe).

As the first shell further includes a single-atom catalyst including a transition metal, it may lower the energy barrier for the sulfur conversion reaction and promote charge transfer to lithium polysulfide, thereby improving the electrocatalytic performance of the cathode active material for a lithium-sulfur cell.

According to one embodiment of the present disclosure, the conductive polymer may be any one or more selected from the group consisting of polypyrrole, polyfluorene, polyphenylene, polypyrene, polyazulene, polynaphthalene, polycarbazole, polyindole, polyazepine, polyaniline, polythiophene, poly (3,4-ethylenedioxythiophene), poly (p-phenylene sulfide), polyacetylene, poly (p-phenylene vinylene), poly (3,4-ethylenedioxythiophene)-polystyrene sulfonate (PEDOT-PSS), derivatives thereof, and copolymers thereof. As the conductive polymer is any one or more selected from among those described above, it may effectively keep the multilayer core-shell structure from large volume changes caused by charging and discharging of the cell, and greatly improve the cycle life characteristics of the cell.

In the cathode active material for a lithium-sulfur cell according to one embodiment of the present disclosure, the content of the core containing sulfur may be 70 parts by weight to 95 parts by weight, specifically 75 parts by weight to 95 parts by weight, or 80 parts by weight to 95 parts by weight, based on 100 parts by weight of the total weight of the multilayer core-shell structure. As the content of the core containing sulfur satisfies the above-mentioned range, the energy density of a cell including the cathode active material for a lithium-sulfur cell may be high.

According to one embodiment of the present disclosure, when the single-atom catalyst includes iron (Fe), the content of iron contained in the multilayer core-shell structure may be 0.1 wt % to 10 wt %. More specifically, the content of iron may be 0.5 wt % to 7.5 wt %, 1.0 wt % to 7.5 wt %, 2.0 wt % to 10 wt %, or 2.0 wt % to 7.5 wt %. Preferably, the content of iron may be 2.0 wt % to 6.5 wt %, 2.5 wt % to 6.5 wt %, 2.0 wt % to 6.0 wt %, or 2.5 wt % to 6.0 wt %. As the single atom catalyst contains iron (Fe) and the content of iron satisfies the above-mentioned range, the single-atom catalyst may exist in a dispersed state without agglomerating in the first shell, and the electrocatalytic effect of the cathode active material for a lithium-sulfur cell may be improved.

In the cathode active material for a lithium-sulfur cell according to one embodiment of the present disclosure, the average diameter of the multilayer core-shell structures may be 100 nm to 1,000 nm. More specifically, the average diameter may be 100 nm to 800 nm, 100 nm to 600 nm, 100 nm to 500 nm, 100 nm to 400 nm, 100 nm to 350 nm, 200 nm to 1,000 nm, 200 nm to 800 nm, 200 nm to 600 nm, 200 nm to 500 nm, 200 nm to 400 nm, 200 nm to 350 nm, 250 to 1,000 nm, 250 nm to 800 nm, 250 nm to 500 nm, 250 nm to 400 nm, or 250 nm to 350 nm. As the average diameter of the multilayer core-shell structures satisfies the above-mentioned range, the surface area of the cathode active material may be large and the deterioration in performance due to agglomeration between particles may be prevented.

Another embodiment of the present disclosure may provide a lithium-sulfur cell including: a cathode including the cathode active material for a lithium-sulfur cell according to one embodiment of the present disclosure; an anode; and an electrolyte.

According to one embodiment of the present disclosure, the anode may include, as an anode active material, a material capable of reversible intercalation/deintercalation of lithium ions. For example, the anode may include, as an anode active material, lithium metal, a lithium alloy, crystalline carbon, amorphous carbon, tin oxide, titanium nitrate, or silicon, but any anode active material may be used without particular limitation as long as it is commonly used as an anode for a lithium-sulfur cell.

According to one embodiment of the present disclosure, the electrolyte contains lithium ions and serves as a mediator to cause an electrochemical oxidation or reduction reaction at the cathode and the anode. The electrolyte may be a non-aqueous electrolyte or solid electrolyte that does not react with lithium metal, wherein the non-aqueous electrolyte may include a lithium salt and an organic solvent.

Specifically, the lithium salt may be any one selected from the group consisting of LiSCN, LiBr, LiI, LiPF₆, LiBF₄, LiB₁₀Cl₁₀, LiSO₃CF₃, LiCl, LiclO₄, LiSO₃CH₃, LiB(Ph)₄, LiC(SO₂CF₃)₃, LiN (CF₃SO₂)₂, LiCF₃CO₂, LiAsF₆, LiSbF₆, LiAlCl₄, LiFSI, lithium chloroborane, and lithium lower aliphatic carboxylate, and the organic solvent may be ether, ester, amide, linear carbonate, cyclic carbonate, etc., which may be used alone or in a combination of two or more, but any solvent may be used without particular limitation as long as it is commonly used in lithium-sulfur cells.

### Method for Producing Multilayer Core-Shell Structure

Another embodiment of the present disclosure provides a method for producing a multilayer core-shell structure, including steps of: mixing a solution containing a first polymer and a solution containing an organic linker comprising a multifunctional organic compound to obtain a solution having dispersed therein a network structure formed by non-covalent interaction between the first polymer and the organic linker; adding a material for core growth to the solution having dispersed therein the network structure to obtain a core-first shell intermediate; and forming a second shell including a second polymer by adding a monomer for the second polymer to the solution containing the core-first shell intermediate, followed by reaction.

For the first polymer and the organic linker, reference may be made to the above-described contents. According to one embodiment of the present disclosure, the solution containing the first polymer and the solution containing the organic linker containing the multifunctional organic compound may each further contain an appropriate solvent, and each of the solutions may contain 0.1 to 10 wt % of the first polymer and 0.1 to 10 wt % of the organic linker.

According to one embodiment of the present disclosure, in the step of mixing the solution containing the first polymer and the solution containing the organic linker to obtain the solution having dispersed therein the network structure, the solution containing the first polymer and the solution containing the organic linker including the multifunctional organic compound may be mixed together at a weight ratio of 500:1 to 10:1. As the above-mentioned range is satisfied, it is possible to adjust the particle diameter of the produced multilayer core-shell structures, and form the first shell including a supramolecular structure which is a network formed by non-covalent interaction between the first polymer and the organic linker.

The material for core growth may be a reactive material for forming a material forming the core. For example, when the core contains sulfur, the material for core growth may include hydrochloric acid and a sulfur precursor, which is a material for acid-catalyzed disproportionation reaction for the formation of sulfur(S).

As the core grows by adding the material for core growth to the solution having dispersed therein the network structure, followed by reaction, the core is naturally surrounded by the dispersed network structure when the core reaches a certain size, and a core-first shell intermediate including the core and the first shell surrounding the core may be obtained.

After obtaining the core-first shell intermediate, a second shell including a second polymer may be formed by adding a monomer for the second polymer to the solution containing the core-first shell intermediate, followed by reaction.

According to one embodiment of the present disclosure, as the formation and growth of the core is performed in an aqueous solution having the network dispersed therein, the growth of the core may be controlled, and the diameters of the core particles may be uniform.

The method for producing a multilayer core-shell structure according to one embodiment of the present disclosure may further include a step of forming a single-atom catalyst that coordinates with the organic linker, before the step of forming the second shell.

More specifically, the step of forming the single-atom catalyst may be performed by dispersing the core-first shell intermediate in a solvent and then adding a precursor of the single atom catalyst thereto.

According to one embodiment of the present disclosure, the sulfur precursor included in the material for core growth may be a compound containing a thiosulfate (S₂O₃²⁻) salt, or a hydrate thereof. For example, the sulfur precursor may be sodium thiosulfate (Na₂S₂O₃) or potassium thiosulfate (K₂S₂O₃).

Hereinafter, the present disclosure will be described in detail by way of examples. However, the examples according to the present disclosure may be modified into various different forms, and the scope of the present disclosure is not interpreted as being limited to the examples described below. The examples of the present specification are provided to more completely explain the present disclosure to those skilled in the art.

In the following examples, all electrochemical experiments were performed at 30° C.

### Example 1: Multilayer Core-Shell Particles (S@PTF/PPy) Having Single-Atom Catalyst Introduced Thereinto

(1) Synthesis of Core-First Shell Intermediate Including Core Containing Sulfur and First Shell Surrounding Core

First, 1.515 g of polyvinylpyrrolidone (PVP, Mw=55,000, Sigma-Aldrich) as a first polymer was added to 150 mL of distilled water, followed by stirring at 500 rpm, thus preparing an aqueous polyvinylpyrrolidone solution. Meanwhile, 72 mg of tannic acid (TA, Sigma-Aldrich) as an organic linker was dissolved in 6 ml of distilled water, thus preparing an aqueous tannic acid solution. Then, the aqueous tannic acid solution was added to the aqueous polyvinylpyrrolidone solution, followed by stirring at 500 rpm to obtain a solution having dispersed a PVP-TA network formed by hydrogen bonding between polyvinylpyrrolidone and tannic acid.

Then, 1.1 mL of concentrated hydrochloric acid (35 to 37 wt %, SAMCHUN) and 5 ml of an aqueous solution containing 1 g of sodium thiosulfate as a material for growing a sulfur core were added to the solution having dispersed therein the PVP-TA network, causing a disproportionation reaction of sodium thiosulfate. Through the above reaction, spherical core particles containing sulfur could grow, and particles having a sulfur core-first shell structure including the sulfur-containing core surrounded by the PVP-TA network shell were obtained. The obtained particles are hereinafter referred to as “S@PT”.

(2) Formation of Single-Atom Catalyst

First, the obtained S@PT was washed several times with dilute hydrochloric acid (pH=2.5) using a vacuum filter, and then placed in 150 mL of distilled water and dispersed by sonication. Thereafter, 5 mL of an aqueous solution of ferric chloride hexahydrate (FeCl₃·6H₂O, 6 g/L, Sigma-Aldrich) was added to the aqueous solution having S@PT dispersed therein to form an Fe single-atom catalyst that coordinates with the tannic acid organic linker, thus obtaining particles having a core-first shell structure including the single-atom catalyst formed. The obtained particles are hereinafter referred to as “S@PTF”.

(3) Step of Forming Second Shell Including Conductive Polymer

First, the obtained S@PTF was washed several times with diluted hydrochloric acid (pH=2.5) using a vacuum filter, and then then placed in 75 mL of distilled water and dispersed by sonication. Next, 100 mg of ferric chloride hexahydrate was added to the aqueous solution having S@PTF dispersed therein, followed by stirring at 500 rpm for 10 minutes. Then, 0.03 mL of a solution of pyrrole (Tokyo Chemical Industry) as a monomer for a conductive polymer was added to the aqueous solution having the S@PTF dispersed therein, followed by stirring at 500 rpm for 6 hours to form a second shell including polypyrrole, thus producing particles having a core-first shell-second shell structure (hereinafter referred to as “S@ PTF/PPy” or “S@PTF_2. 6/PPy”).

### Example 1-2: Multilayer Core-Shell Particles (S@PT/PPy)

Particles having a core-first shell-second shell structure (hereinafter referred to as “S@ PT/PPy”) were produced in the same manner as in Example 1, except that the single-atom catalyst was not formed.

### Example 1-3: Multilayer Core-Shell Particles Having Single-Atom Catalyst Introduced Thereinto (S@PTF 0.6/PPy)

Particles having a core-first shell-second shell structure (hereinafter referred to as “S@PTF 0.6/PPy”) were produced in the same method as in Example 1, except that 1.67 mL of an aqueous solution of ferric chloride hexahydrate (FeCl₃·6H₂O, 6 g/L, Sigma-Aldrich) was added in the step of forming the single-atom catalyst.

### Example 1-4: Multilayer Core-Shell Particles Having Single-Atom Catalyst Introduced Thereinto (S@PTF 6.2/PPy)

Particles having a core-first shell-second shell structure (hereinafter referred to as “S@PTF 6.2/PPy”) were produced in the same method as in Example 1, except that 10 mL of an aqueous solution of ferric chloride hexahydrate (FeCl₃·6H₂O, 6 g/L, Sigma-Aldrich) was added in the step of forming the single-atom catalyst.

### Comparative Example 1: Production of S@PVP Particles

First, 1.515 g of polyvinylpyrrolidone (PVP, Mw=55,000, Sigma-Aldrich) was added to 150 mL of distilled water, followed by stirring at 500 rpm, thus preparing an aqueous polyvinylpyrrolidone solution. Then, 5 mL of an aqueous solution containing 1 g of sodium thiosulfate and 1.1 ml of concentrated hydrochloric acid (35 to 37 wt %, SAMCHUN) were added to the aqueous polyvinylpyrrolidone solution, causing a disproportionation reaction of sodium thiosulfate. Through the above reaction, spherical core particles containing sulfur could grow, and core-shell particles including the sulfur-containing core surrounded by the PVP shell were produced. The produced particles are hereinafter referred to as “S@ PVP”.

<Characterization of Multilayer Core-Shell Particles>

Experimental Example 1-1: SEM Analysis of Multilayer Core-Shell Particles

To investigate the shapes and sizes of the sulfur-containing core-shell particles (S@PT, S@PTF, S@PTF/PPy, and S@PVP) obtained in Example 1 and Comparative Example 1, SEM images were obtained using a field-emission scanning electron microscope (FESEM, SUPRA 55VP, Carl Zeiss).

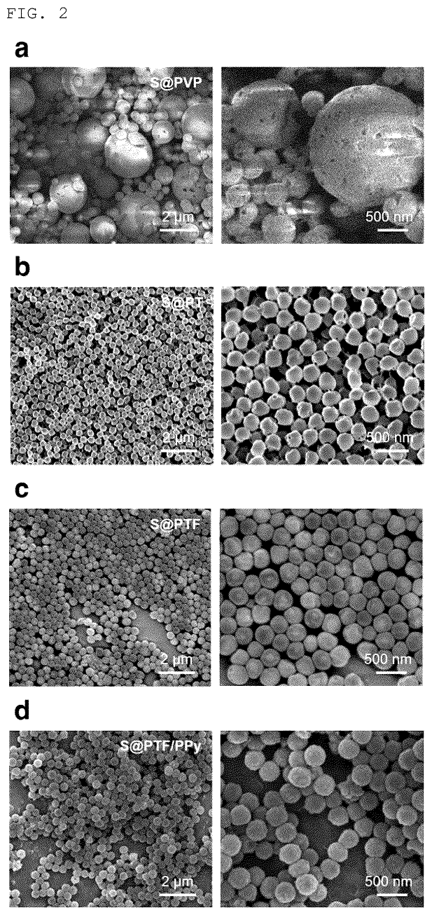

FIG. 2 shows SEM images of S@PVP (a) produced in Comparative Example 1, and S@PT (b), S@PTF (c), and S@PTF/PPy (d) obtained in Example 1. Referring to FIG. 2A, it can be seen that the S@PVP particles produced without using tannic acid when forming the first shell do not have a uniform diameter, and some S@PVP particles have a diameter of about 1 to 2 μm. Referring to FIGS. 2B to 2D, it can be seen that the S@PT, S@PTF and S@PTF/PPy obtained in Example 1 have particle diameters smaller than 500 nm and have very uniform diameters, and that S@PTF/PPy having the second shell including PPy have a rough surface, unlike S@PT and S@PTF particles, which have smooth surfaces.

Furthermore, the diameter distribution for each of S@PT, S@PTF and S@PTF/PPy was measured by analyzing SEM images taken for S@PT, S@PTF, and S@PTF/PPy, and the diameter of the sulfur core included in S@PTF/PPy was determined through EDS line scan analysis of sulfur and iron elements for S@PTF/PPy using a scanning electron microscope (TEM, JEM-2100F, JEOL). In addition, the diameter distributions of S@PT, S@PTF, and S@PTF/PPy were measured once more by dynamic light scattering (DLS, ELSZ 1000, Otsuka electronics) analysis. Since DLS analysis is to measure the hydrodynamic diameter of particles in Brownian motion in solution, the measured diameter is approximately 10% larger than the actual diameter, and thus correction is necessary.

Table 1 below shows the average particle diameter values and standard deviations of the sulfur cores included in S@PTF/PPy, S@PT, S@PTF, and S@PTF/PPy.

TABLE 1

| | Average particle diameter (nm) / standard deviation (%) | | | |
|---|---|---|---|---|
| Measurement | Sulfur | | | |
| method | core (S) | S@PT | S@PTF | S@PTF/PPy |
| TEM line scan | 261.7 | — | 277.5 | 306.9 |
| SEM | — | 279.9 / 5.9 | 283.5 / 7.2 | 306.3 / 10.4 |
| DLS | — | 310.2 / 9.2 | 312.7 / 10.1 | 339.2 / 8.16 |

Referring to Table 1, the average diameter of the sulfur cores included in S@PTF/PPy was 261.7 nm, and the average diameter of S@PTF/PPy including the sulfur core, first shell, and second shell was 306.9 nm.

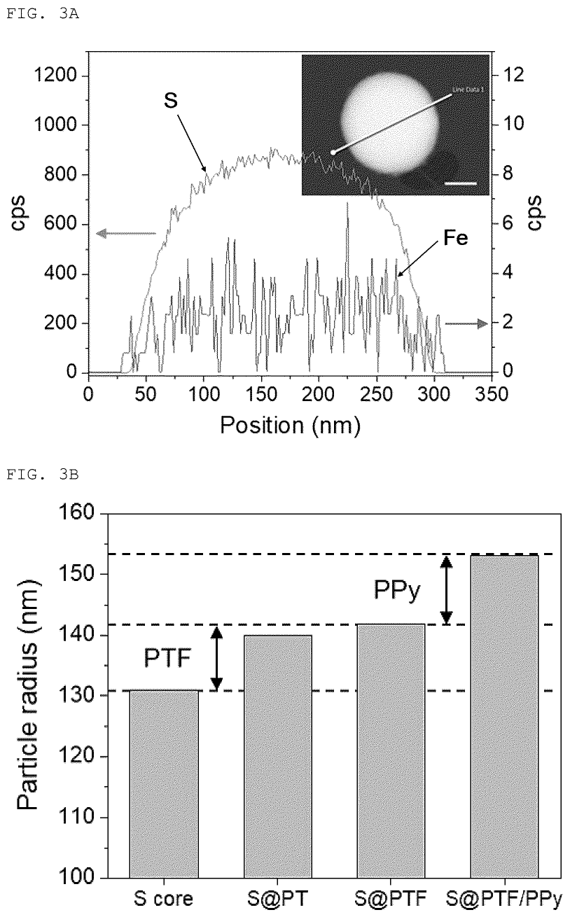

FIG. 3A shows the results of TEM line scan analysis for S@PTF/PPy produced in Example 1. Referring to FIG. 3A, thanks to the rigid shell structure, S@PTF/PPy maintained its core-shell structure without particle collapse even under extreme vacuum conditions during TEM measurements, and the sulfur element signal was uniformly distributed along the scan line and showed that the diameter of the sulfur core was 261.7 nm. In addition, the iron element signal was distributed slightly longer than the sulfur element signal, and the uniform distribution of the iron element signal indicated that iron was uniformly distributed without agglomeration.

FIG. 3B shows the average radius of each of the sulfur core included in S@PTF/PPy produced in Example 1, S@PT, S@PTF, and S@PTF/PPy. Based on the average diameters of the sulfur core, S@PT, S@PTF, and S@PTF/PPy, measured through SEM image analysis and TEM line scan analysis, the thickness of each shell was determined by calculating the particle radius difference between adjacent steps. Referring to FIG. 3B, the thickness of the first shell (PT) into which the single-atom catalyst was not introduced was 9.1 nm, the thickness of the first shell (PTF) into which iron was introduced as a single-atom catalyst was 10.9 nm, and the thickness of the second shell (PPy) including polypyrrole was 11.4 nm.

### Experimental Example 1-2: Analysis of Components of Multilayer Core-Shell Particles

Thermogravimetric analysis (TGA) was performed to investigate the components and quantitative contents of the components of the sulfur-containing core-shell particles (S@PT, S@PTF, and S@PTF/PPy) obtained in Example 1. Specifically, the content of sulfur was measured by performing TGA analysis using a thermogravimetric analyzer (SDT Q600, TA Instruments) at 500° C. under a nitrogen atmosphere, and the contents of PVP, TA, Fe, and PPy were calculated based on the measured sulfur content. The content of Fe was analyzed in duplicate by inductively coupled plasma mass spectrometry (ICP-MS, JP7900, Agilent Technologies).

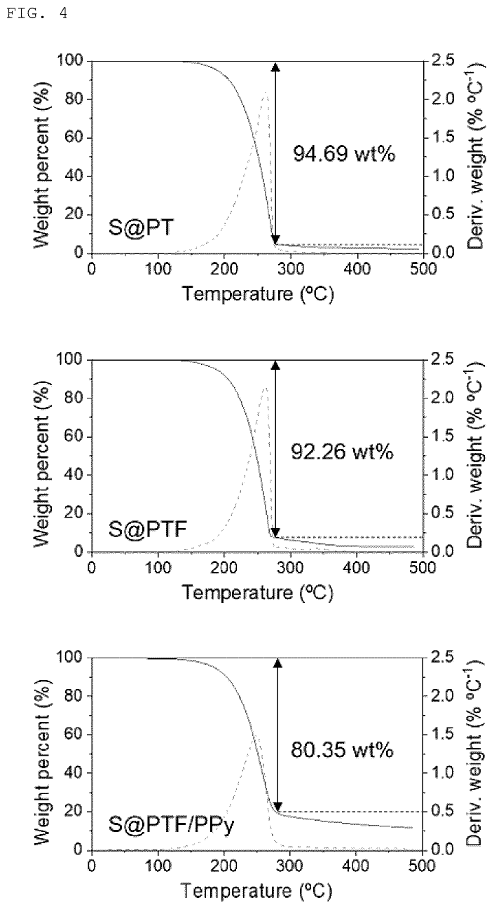

FIG. 4 shows the TGA curve and sulfur content measured for each of S@PT, S@PTF, and S@PTF/PPy obtained in Example 1. Referring to FIG. 4, it can be seen that the mass of the particles was decreased due to sulfur decomposition when heated from about 100° C. to about 280° C., indicating that the mass remaining after heating is the mass of the components excluding sulfur.

Table 2 below shows the components of S@PT, S@PTF, and S@PTF/PPy, and the content of each component.

TABLE 2

| wt % | S@PT | S@PTF | S@PTF/PPy |
|---|---|---|---|
| S | 94.69 | 92.26 | 80.35 |
| PVP and TA | 5.31 | 5.31 | 5.31 |
| Fe | — | 2.43 | 2.43 |
| PPy | — | — | 11.91 |

Referring to FIG. 4 and Table 2 above, the sulfur contents of S@PT, S@PTF, and S@PTF/PPy were 94.69 wt %, 92.26 wt %, and 80.35 wt %, respectively. Through the above experiment, it was confirmed that the cathode active material for a lithium-sulfur cell according to the present disclosure had a sulfur content of 80 wt % or more.

### Experimental Example 1-3: Raman Spectral Analysis of Multilayer Core-Shell Particles

Raman spectral analysis was performed to investigate chemical bonding information on the sulfur-containing core-shell particles (S@PT, S@PTF, and S@PTF/PPy) obtained in Example 1. Specifically, the analysis was performed using a Raman spectrometer (Raman plus, Nanophoton) in an acquisition time range of 60 to 300 seconds and an energy range of 0.5 to 0.8 mW.

FIG. 5 shows the Raman spectra of S@PT, S@PTF, and S@PTF/PPy obtained in Example 1. Referring to FIG. 5, it can be seen that peaks corresponding to PVP and TA exist in the Raman spectrum of S@PT. In the Raman spectrum of S@PTF, not only peaks corresponding to PVP and TA, but also a peak (TA-Fe) due to the coordination bond between Fe and TA appear near 600 cm-1. It can be seen that the peak corresponding to PPy is dominant in the Raman spectrum of S@PTF/PPy, in which the second shell surrounding the first shell was formed.

### Experimental Example 1-4: Investigation of Chemical Stability of Multilayer Core-Shell particles Against Electrolyte

In order to investigate the chemical stability of the sulfur-containing core-shell particles (S@PTF and S@PTF/PPy), obtained in Example 1, against an electrolyte, S@PTF and S@PTF/PPy were dispersed in DOL/DME (DOL: 1,3-dioxolane, DME: 1,2-dimethoxyethane, 1:1 volume ratio, Sigma-Aldrich), and then filtered. Next, SEM images of the produced S@PTF and S@PTF/PPy were obtained using a field-emission scanning electron microscope.

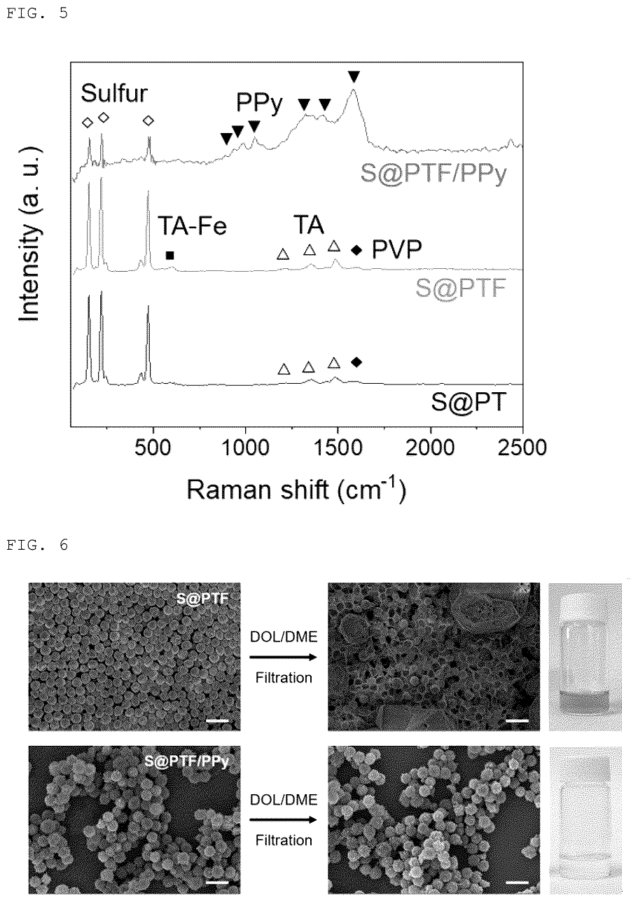

FIG. 6 shows SEM images of S@PTF and S@PTF/PPy, obtained in Example 1, before and after dispersion in an electrolyte, and photographs of the electrolyte solution. Referring to FIG. 6, it was confirmed that, in the case of S@PTF in which the second shell was not formed, the first shell was collapsed by the electrolyte, and PVP, TA, and Fe contained in the first shell were dissolved in the electrolyte solution, and the filtered electrolyte solution turned purple.

on the other hand, it was confirmed that, in the case of S@PTF/PPy, in which the second shell surrounding the first shell was the particles maintained their shape without collapsing even when dispersed in the electrolyte, and the filtered electrolyte solution maintained transparency, indicating that S@PTF/PPy maintained its chemical stability against the electrolyte.

Through the above experiment, it was confirmed that the second shell including polypyrrole could reduce the amount of electrolyte flowing into the shell, thereby limiting electrolyte access and protecting the first shell inside the second shell.

### Example 2-1: Lithium-Sulfur Beaker Cell Including S@ PTF/PPY

S@PTF/PPy produced in Example 1 was used as a cathode active material.

First, S@PTF/PPy, carbon black (Super P) as a conductive material, and a binder were mixed together at a weight ratio of 8:1:1 to form a homogeneous slurry. An aluminum foil was coated with the slurry using a doctor blade, and the coated slurry was vacuum-dried at room temperature to obtain a sulfur electrode including S@PTF/PPy. The sulfur electrode as a working electrode, and a lithium metal foil electrode as a reference electrode and a counter electrode were installed in a beaker. At this time, the thickness and area of the lithium metal foil were 0.7 mm and 2.01 cm², respectively. As an electrolyte, a total of 15 mL of a DOL/DME solution (DOL: 1,3-dioxolane, DME: 1,2-dimethoxyethane, 1:1 volume ratio, Sigma-Aldrich) containing 1M lithium bis(trifluoromethanesulfonyl) imide (LiTFSI, Sigma-Aldrich) and lithium nitrate (1 wt %, LiNO3, Sigma-Aldrich) was filled into the beaker. Then, the beaker was sealed with a paraffin film, thereby fabricating a lithium-sulfur beaker cell.

### Comparative Example 2: Lithium-Sulfur Beaker Cell Including KB-S Composite Electrode

A beaker cell was fabricated in the same manner as in Example 2-1, except that an electrode obtained using, as a cathode active material, a KB-S composite produced by mixing Ketjen black and sulfur at a weight ratio of 7:3 and heat-treating the mixture at 155° C. for 12 hours was used as the working electrode.

### Experimental Example 2-1: Examination of Whether S@PTF/PPy Is Permeable to Lithium Polysulfides (LiPSs)

In order to examine whether the shell of S@PTF/PPy prevents lithium polysulfide from being lost to the outside of the core-shell particles by blocking the permeation of lithium polysulfides, the lithium-sulfur beaker cells fabricated in Example 2-1 and Comparative Example 2 were discharged, and then visual observation and UV-Vis spectroscopy (V-770, JASCO) analysis were performed. Specifically, after discharging, UV-Vis spectroscopic analysis was performed on the electrolyte of each beaker cell to obtain UV-Vis absorption spectra. Assuming that all sulfur in the S@PTF/PPy sulfur electrode was completely dissolved in the electrolyte, a Li₂S₈ solution was prepared as a reference solution.

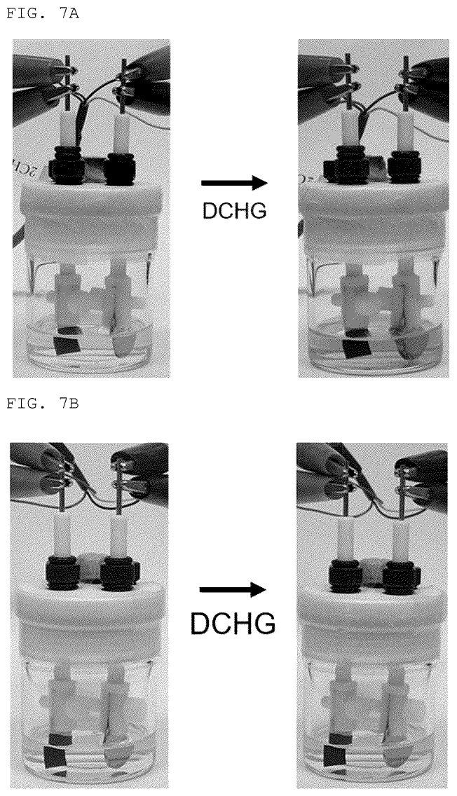

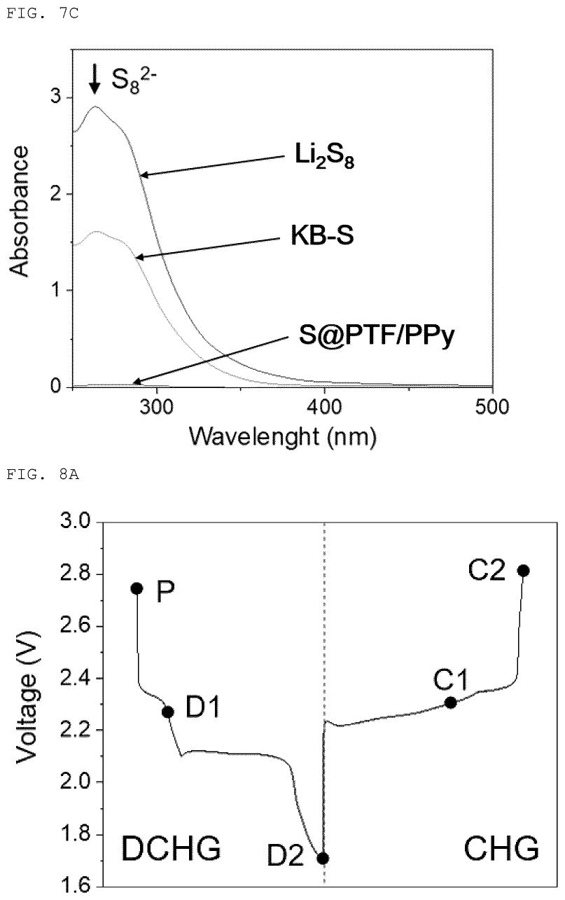

FIGS. 7A and 7B show photographs of the lithium-sulfur beaker cells of Comparative Example 2 and Example 2-1, respectively, taken after discharging.

Referring to FIGS. 7A and 7B, in the case of the lithium-sulfur beaker cell of Example 2-1 including S@PTF/PPy as the cathode active material, the electrolyte solution maintained its transparency even after complete discharging of the cell, whereas, in the lithium-sulfur beaker cell of Comparative Example 2 including the KB-S composite rather than S@PTF/PPy as the cathode active material, the electrolyte solution changed to yellow after discharging of the cell. It was confirmed that, in the case of the electrode including the KB-S composite as the cathode active material, lithium polysulfide was lost from the electrode to the electrolyte due to discharging, whereas, in the case of the electrode including S@PTF/PPy as the cathode active material, lithium polysulfide was not lost to the electrolyte.

FIG. 7C shows the UV-Vis absorption spectra of the electrolyte and the reference solution (Li₂S₈) after discharging of the lithium-sulfur beaker cells of Comparative Example 2 and Example 2-1. Referring to FIG. 7C, it was confirmed that, in the case of the lithium-sulfur beaker cell of Example 2-1, the amount of lithium polysulfide contained in the electrolyte after discharging of the cell was negligibly small compared to that in the reference solution (Li₂Ss), whereas, in the case of Comparative Example 2, the amount of lithium polysulfide contained in the electrolyte after discharging of the cell was about 50% of that in the reference solution (Li₂Ss). This indicates that almost 50% of the sulfur contained in the KB-S composite was lost to the electrolyte, and that the sulfur contained in S@PTF/PPy is not lost to the electrolyte even after discharging of the cell.

### Experimental Example 2-2: Stability against Volume Changes Caused by Charging and Discharging

Ex-situ characterization was performed to investigate whether S@PTF/PPy would operate stably despite large volume changes caused by charging and discharging of the cell. Specifically, during discharging and charging of the lithium-sulfur beaker cell fabricated in Example 2-1, and at the discharge points (D1, and D2), charge points (C1, and C2), and start point (P), SEM images, particle diameter distributions, and Raman spectra were obtained for the sulfur electrode including S@PTF/PPy as the cathode active material. The measurement methods and conditions for the SEM images, particle diameter distributions, and Raman spectra are the same as those described in Experimental Examples 1.1 and 1.3.

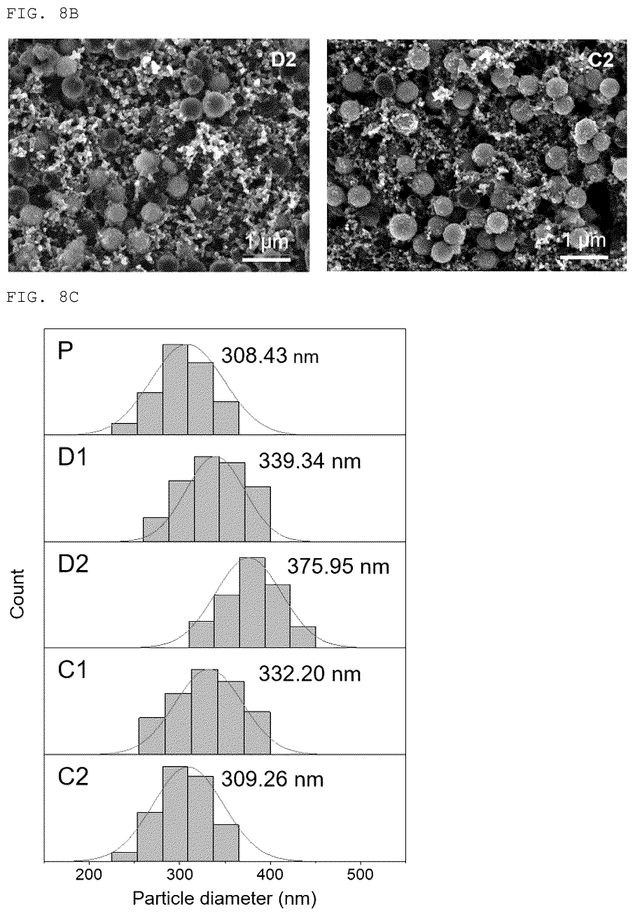

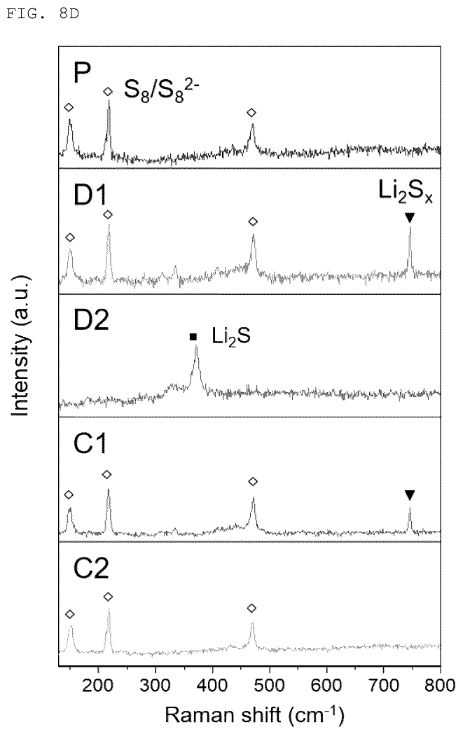

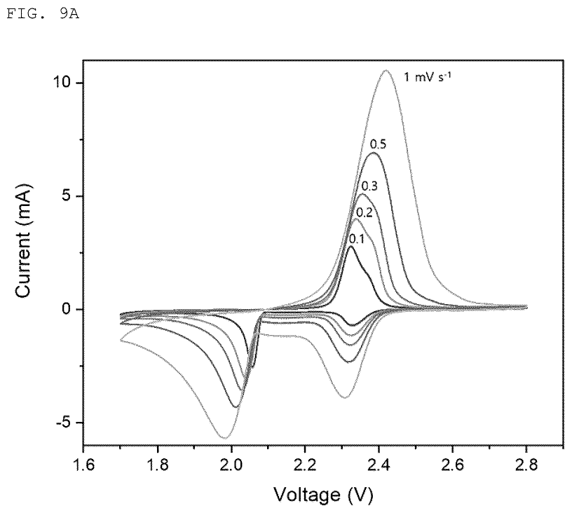

FIG. 8A shows the charge and discharge voltage profiles of the lithium-sulfur beaker cell of Example 2-1. Referring to FIG. 8A, the charge and discharge voltage profiles of the lithium-sulfur beaker cell showed two voltage plateau zones connected by a sloping region resulting from a multi-step reaction of sulfur.

FIG. 8B shows SEM images of S@PTF/PPy at the discharge end point (D2) and charge end point (C2) of the lithium-sulfur beaker cell of Example 2-1. Referring to FIG. 8B, it was confirmed that S@PTF/PPy maintained its shape without collapsing even after the end of discharge and the end of charge, and S@PTF/PPy easily accommodated volume expansion at the discharge end point (D2) and returned to its original state at the charge end point (C2).

FIG. 8C shows S@PTF/PPy particle diameter distributions at discharge points (D1 and D2), charge points (C1 and C2), and start point (P), measured for the lithium-sulfur beaker cell of Example 2-1. Referring to FIG. 8C, it was confirmed that the diameter of S@PTF/PPy increased as sulfur(S) was converted to LizS during discharging of the cell, and the diameter of S@PTF/PPy decreased as LizS was converted back to sulfur during charging of the cell.

Table 3 below shows the changes in average particle diameters of S@PTF/PPy at the discharge points (D1 and D2), charge point (C1 and C2), and start point (P), and the volume changes of S@PTF/PPy, calculated based on the average particle diameters.

TABLE 3

| | P | D1 | D2 | C1 | C2 |
|---|---|---|---|---|---|
| Average particle | 308.4 | 339.3 | 376.0 | 332.2 | 309.3 |
| diameter (nm) | | | | | |
| Standard | 13.1 | 9.5 | 9.8 | 11.1 | 12.4 |
| deviation (%) | | | | | |
| Increase rate (%) | — | 10.0 | 21.9 | 7.7 | 0.3 |
| Particle volume | 161.4 | 210.1 | 286.0 | 199.0 | 161.8 |
| (×10⁵ nm³) | | | | | |
| Standard | 37.9 | 27.3 | 27.2 | 32.3 | 37.3 |
| deviation (%) | | | | | |
| Increase rate (%) | — | 30.2 | 77.2 | 23.3 | 0.2 |

Referring to Table 3 above, it was confirmed that S@PTF/PPy showed a volume increase rate of about 77.2% at the discharge end point (D2) relative to that at the start point (P), which is very similar to the theoretical value of 80%. In addition, it was confirmed that S@PTF/PPy returned to almost the same volume (0.2%) at the charge end point (C2) as that at the start point (P). In other words, it was confirmed that S@PTF/PPy according to the present disclosure could very well withstand volume changes caused by charging and discharging of the battery.

FIG. 8D shows the Raman spectra of S@PTF/PPy at discharge points (D1 and D2), charge points (C1 and C2), and start point (P), measured for the lithium-sulfur beaker cell of Example 2-1. Referring to FIG. 8D, peaks corresponding to S₈/S₈²⁻and Li₂Sₓ (4≤×≤8) can be seen in the Raman spectrum of S@PTF/PPy at point D1 during discharge. In contrast, only one peak corresponding to Li₂S appears in the Raman spectrum of S@PTF/PPy at the discharge end point (D2), indicating that the sulfur core of S@PTF/PPy has been completely converted to Li₂S. In addition, the Raman spectrum at the charge point (C1) and the Raman spectrum at the charge end point showed peaks in the same manner as the Raman spectrum at the discharge point (D1) and the Raman spectrum at the start point (P), respectively. That is, it was confirmed that the sulfur core of S@PTF/PPy according to the present disclosure could stably perform oxidation/reduction reactions even when surrounded by the first and second shells.

### Example 3-1: S@PTF/PPy Coin Cell

A 2032-type coin half-cell was fabricated in an Ar-charged glove box (KK-011 MS, Korea Research Institute) as follows. S@PTF/PPy produced in Example 1 was used as the cathode active material.

First, S@PTF/PPy, carbon black (Super P) as a conductive material, and a binder were mixed together at a weight ratio of 8:1:1 in NMP to form a homogeneous slurry. An aluminum foil was coated with the slurry using a doctor blade, and the coated slurry was vacuum-dried at room temperature to obtain an electrode including S@PTF/PPy. The above electrode was used as a working electrode, and a lithium metal foil electrode was used as a reference electrode and a counter electrode. At this time, the thickness and area of the lithium metal foil were 0.7 mm and 2.01 cm², respectively. As an electrolyte, a DOL/DME solution (DOL: 1,3-dioxolane, DME: 1,2-dimethoxyethane, 1:1 volume ratio, Sigma-Aldrich) containing 1M lithium bis(trifluoromethanesulfonyl)imide (LiTFSI, Sigma-Aldrich) and lithium nitrate (1 wt %, LiNO3, Sigma-Aldrich) was used.

### Example 3-2

A coin half-cell was fabricated in the same manner as Example 3-1, except that S@PTF_0.6/PPy was used as the cathode active material.

### Example 3-3

A coin half-cell was fabricated in the same manner as Example 3-1, except that S@PTF_6.2/PPy was used as the cathode active material.

### Example 3-4: S@PT/PPy Coin Cell

A coin half-cell was fabricated in the same manner as Example 3-1, except that S@PT/PPy was used as the cathode active material.

### Comparative Example 3: KB-S Composite Coin Cell

A coin half-cell was fabricated in the same manner as Example 3-1, except that a KB-S composite produced by mixing Ketjen black and sulfur at a weight ratio of 7:3 and heat-treating the mixture at 155C for 12 hours was used as the cathode active material.

### Experimental Example 3-1: Analysis of Electrocatalytic Effect of S@PTF/PPy

Cyclic voltammetry (CV) measurements were performed on the lithium-sulfur coin cells fabricated in Examples 3-1 to 3-3 in order to investigate the catalytic effect of S@PTF/PPy on the sulfur conversion reaction. Specifically, CV measurements were performed at a scan rate of 0.1 to 1 mV·s⁻¹ in a voltage range of 1.7 to 2.8 V (V vs Li/Lit), and the electrode of the half-cell discharged to 2.25 V was reassembled into a symmetric cell to perform CV measurements of the symmetric cell.

A potentiostatic discharging test was performed by discharging the cell to 2.12 V at 0.05 C and then maintaining the voltage at 2.11 V until the current reached 0.01 mA, and the current-time transient spectrum was extracted from the potentiostatic discharge curve. The current-time transient spectrum was subjected to multiple linear regression analysis to determine the contribution of four classical models (2DI, 2DP, 3DI, and 3DP). A potentiostatic charging test was performed by maintaining the voltage at 2.4 V until the current reached 0.01 mA.

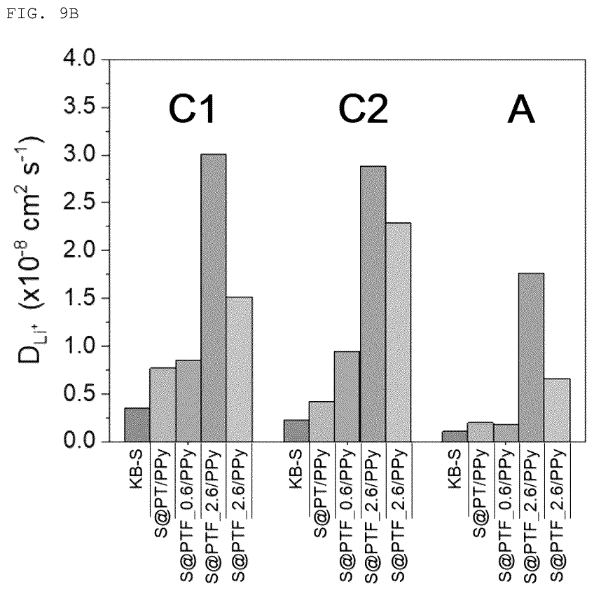

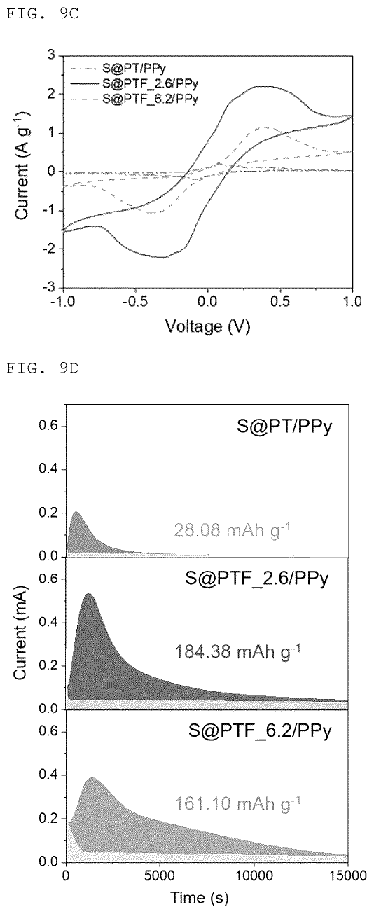

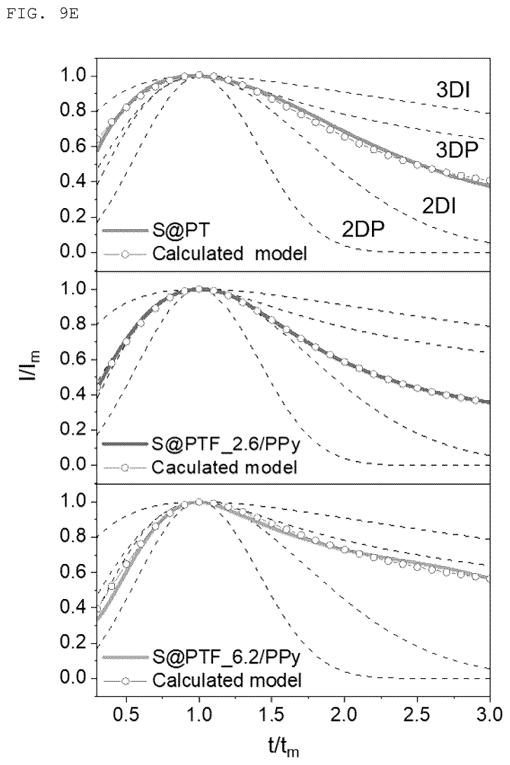

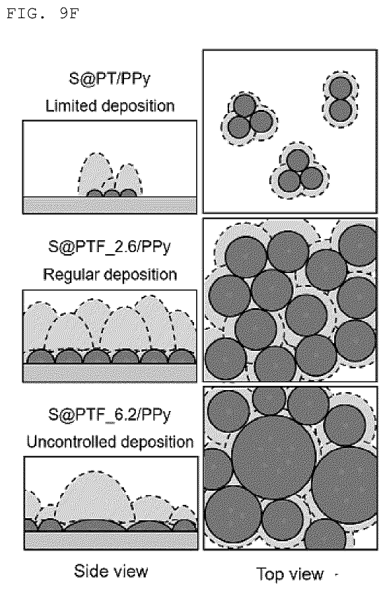

FIG. 9A shows CV curves of the cell of Example 3-1 at a scan rate of 0.1 to 1 mV·s⁻¹. Referring to FIG. 9A, peaks I, II, and III according to the stepwise conversion reactions of sulfur were observed, and low Tafel slopes (Tafel) of 47.19, 14.15, and 45.87 mM dec-1 were shown for peaks I, II, and III, respectively.

Furthermore, diffusion coefficients of lithium ions for the coin cells of Examples 3-1 to 3-4 and Comparative Example 3 were calculated using the Randles-Sevcik equation.

FIG. 9B shows the diffusion coefficients of lithium ions, calculated from peaks I, II, and III for the cells of Examples 3-1 to 3-4 and Comparative Example 3. Referring to FIG. 9B, the cathode active material according to the present disclosure could prevent an increase in the viscosity of the electrolyte by preventing polysulfide from being lost to the electrolyte, and thus the lithium-ion diffusion coefficient of the core-shell particles was higher than that of the cell of Comparative Example 3. In addition, when the content of the single-atom catalyst iron introduced into the first shell in S@PTF/PPy increased from 0.6 to 2.6, the lithium-ion diffusion coefficient increased, but when the content of iron increased from 2.6 to 6.2, the lithium-ion diffusion coefficient decreased slightly.

FIG. 9C shows CV curves obtained by reassembling the cells of Example 3-1, Example 3-3, and Example 3-4 into symmetric cells. Referring to FIG. 9C, it was confirmed that S@PTF/PPy according to the present disclosure had electrochemical reversibility, and that the oxidation/reduction peaks were most evident when the iron content of S@PTF/PPy was 2.6 wt %.

FIGS. 9D and 9E respectively show the current-time transient spectra and potentiostatic discharge test results for the cells of Example 3-1, Example 3-3, and Example 3-4. Referring to FIGS. 9D and 9E, the electrodeposition capacity was greatly improved in S@PTF/PPy with iron introduced as a single-atom catalyst, compared to when S@PT/PPy without iron introduced as a single atom catalyst was used, and the electrodeposition capacity was highest at 184.38 mAh g⁻¹ when the iron content was 2.6 wt %. In addition, the current-time transient spectrum was divided into a nucleation/nuclear growth region (t/tₘ<1) and a nucleation dominant region (t/tₘ >1).

FIG. 9F schematically shows the electrodeposition behavior of LizS. Referring to FIG. 9F, the gray area represents the PVP-TA network corresponding to the first shell, the red dot represents the Fe single-atom catalyst, the brown area represents when t/tₘ<1, and the yellow area represents when t/tₘ<1.

### Experimental Example 3-2: Rate Capability of Lithium-Sulfur Cell Including S@PT/PPy or S@PTF/PPy as Cathode Active Material

In order to investigate the electrochemical performance of coin cells including S@PT/PPy or S@PTF/PPy, the rate capabilities versus cycle number for the coin cells fabricated in Examples 3-1 and 3-4 and Comparative Example 3 were examined. Specifically, the rate capabilities of the cells were measured through galvanostatic charge and discharge tests at various C rates of 0.2 to 5 C (1C=1672 mAg-1). To ensure the reliability of evaluation of electrochemical performance, the tests were performed in triplicate.

Furthermore, polarization was determined by the voltage difference between the discharge profile and the charge profile in the middle of the lower discharge plateau. In addition, the conversion reaction was evaluated by dividing the discharge capacity into upper plateau capacity (Q1) and lower plateau capacity (Q2).

Table 4 below shows the specific capacities and coulombic efficiencies of the S@PTF/PPy coin cell, fabricated in Example 3-1, at various rates.

TABLE 4

| | | | | | | | | Coulombic |
|---|---|---|---|---|---|---|---|---|
| Cell | Specific capacities at various rates (mAh g⁻¹) | | | | | | | efficiency |
| # | 0.2 C | 0.5 C | 1 C | 2 C | 3 C | 4 C | 5 C | (%) |
| 1 | 1,483 | 1,271 | 1,135 | 1,024 | 965 | 915 | 867 | 99.6 |
| 2 | 1,433 | 1,260 | 1,172 | 1,073 | 995 | 910 | 838 | 99.5 |
| 3 | 1,521 | 1,295 | 1,184 | 1,049 | 955 | 899 | 852 | 99.6 |
| Average | 1,479 | 1,275 | 1,164 | 1,049 | 972 | 908 | 852 | — |
| Standard | 2.98 | 1.40 | 2.19 | 2.34 | 2.14 | 0.90 | 1.70 | — |
| deviation | | | | | | | | |
| (%) | | | | | | | | |

Referring to Table 4 above, the cell of Example 3-1 maintained a high specific capacity of about 1,483 mAh g⁻¹ during the first five cycles at 0.2 C, and showed specific capacities of 1,271, 1,135, 1,024, 965, 915, and 867 mAh g⁻¹ at rates of 0.5, 1, 2, 3, 4 and 5 C, respectively.

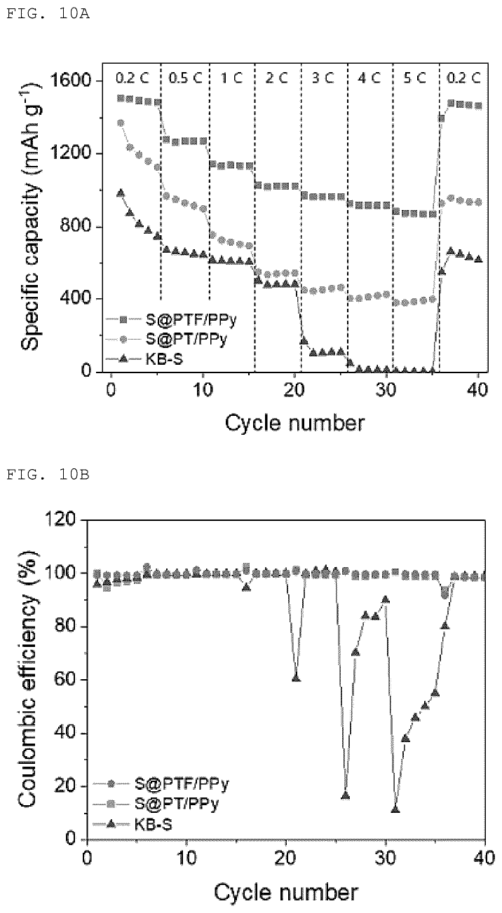

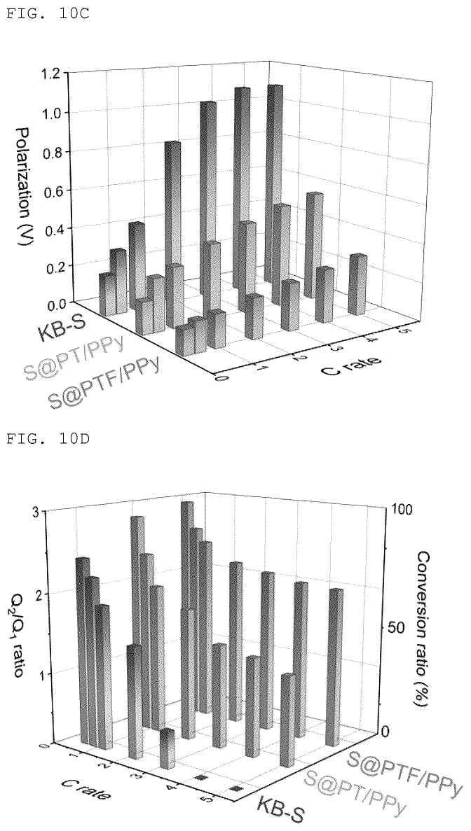

FIGS. 10A and 10B respectively show the rate capability and coulombic efficiency versus cycle number of the cells of Example 3-1, Example 3-4, and Comparative Example 3.

Referring to FIG. 10A, the lithium-sulfur coin cells fabricated in Examples 3-1 and 3-4 had higher specific capacities than the lithium-sulfur coin cell, fabricated in Comparative Example 3, at all rates.

Referring to FIG. 10B, in the case of the lithium-sulfur cells of Examples 3-1 and 3-4 including the cathode active material according to the present disclosure, coulombic efficiency was maintained close to 100% as the number of cycles increased, whereas in the case of the lithium-sulfur cell of Comparative Example 3, coulombic efficiency tended to greatly decrease up to 20% as the number of cycles exceeded 20.

FIGS. 10C and 10D respectively show the polarization and Q2/Q1 ratio of the cells of Example 3-1, Example 3-4, and Comparative Example 3.

Referring to FIG. 10C, it was confirmed that, in the case of the lithium-sulfur cell of Comparative Example 3 including the KB-S composite as the cathode active material, polarization increased rapidly as the C rate increased, whereas in the case of the lithium-sulfur cells of Examples 3-1 and 3-4 including the cathode active material according to the present disclosure, rate of increase in polarization with an increase in the C rate decreased, and in the case of the lithium-sulfur cell of Example 3-1, polarization was significantly reduced due to iron ions uniformly distributed in the first shell.

Referring to FIG. 10D, the lithium-sulfur cells of Examples 3-1 and 3-4 including the cathode active material according to the present disclosure showed a Q2/Q1 ratio close to 3 at 0.2 C, which was higher than that of the lithium-sulfur cell of Comparative Example 3. Considering that the Q2/Q1 ratio is theoretically 3 when all sulfur is converted to LizS, it can be confirmed that the conversion reaction occurs well in the sulfur core inside the shell of the cathode active material according to the present disclosure. In addition, in the case of the lithium-sulfur cell of Comparative Example 3, the Q2/Q1 ratio decreased significantly as the C rate increased, and the Q2/Q1 ratio was 0 at 4 C or higher, whereas in the case of the lithium-sulfur cells of Examples 3-1 and 3-4, the degree to which the Q2/Q1 ratio decreased as the C rate increased was improved, and in the case of the cell of Example 3-1, an excellent Q2/Q1 ratio was maintained even when the C rate increased to 5 C.

### Experimental Example 3-3: Evaluation of Long-Term Stability of Lithium-Sulfur Cell Including S@PTF/PPy as Cathode Active Material

The long-term stability of the lithium-sulfur coin cell fabricated in Example 3-1 was evaluated through charge and discharge tests. Specifically, galvanostatic charge and discharge were performed on the lithium-sulfur coin cell fabricated in Example 3-1 for 500 cycles at 3 C and 5 C. To ensure the reliability of evaluation of electrochemical performance, the tests were performed in triplicate.

Table 5 below shows the specific capacity, coulombic efficiency, and capacity reduction rate per cycle of the lithium-sulfur coin cell fabricated in Example 3-1 after 500 cycles at 3 C and 5 C.

TABLE 5

| | | | Specific | | |
|---|---|---|---|---|---|
| | | Initial | capacity | Capacity | |
| | | specific | (mAh g⁻¹) | reduction | Coulombic |
| C | Coin | capacity | after 500 | rate (%) | efficiency |
| rate | # | (mAh g⁻¹) | cycles | per cycle | (%) |
| 3 C | 1 | 943 | 901 | 0.009 | 98.5 |
| | 2 | 962 | 890 | 0.015 | 98.9 |
| | 3 | 941 | 856 | 0.018 | 98.8 |
| | Average | 949 | 882 | 0.014 | — |
| | Standard | 1.22 | 2.66 | — | — |
| | deviation | | | | |
| | (%) | | | | |
| 5 C | 1 | 861 | 707 | 0.036 | 99.3 |
| | 2 | 844 | 718 | 0.030 | 97.5 |
| | 3 | 874 | 753 | 0.028 | 99.6 |
| | Average | 860 | 725 | 0.031 | — |
| | Standard | 17.75 | 3.31 | — | — |
| | deviation | | | | |
| | (%) | | | | |

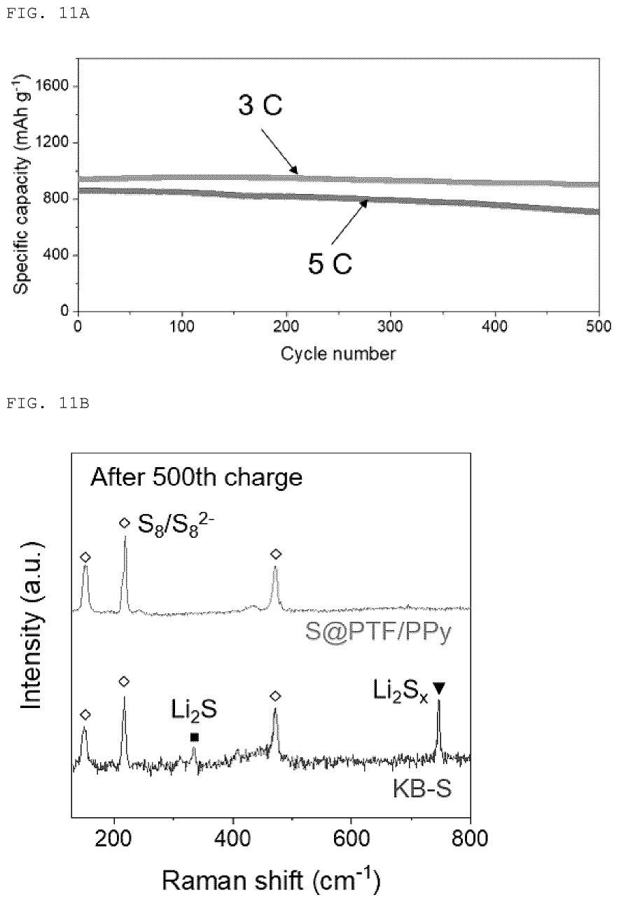

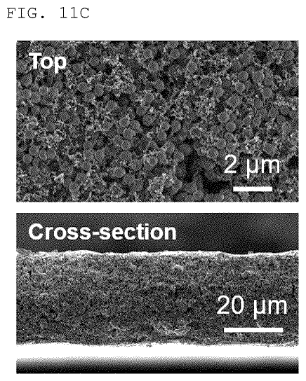

FIG. 11A shows the specific capacity of the cell of Example 3-1 for 500 cycles at 3 C and 5 C.

Referring to FIG. 11A and Table 5 above, it was confirmed that the lithium-sulfur cell of Example 3-1 including the cathode active material according to the present disclosure showed excellent specific capacities of 901 and 707 mAh g⁻¹ even after 500 cycles at 3 C and 5 C, and the capacity reduction rates per cycle were small at 0.009% and 0.036%, indicating that the capacity reduction per cycle of the cell was small even at high C-rates. This suggests that the long-term stability of the cell is excellent.

FIG. 11B shows the Raman spectra of the electrode including S@PTF/PPy and the electrode including the KB-S composite after 500 cycles of charge and discharge at 3 C for the cells of Example 3-1 and Comparative Example 3. Referring to FIG. in the Raman spectrum of the electrode including S@PTF/PPy after 500 cycles, only the peak corresponding to S₈/S₈₂ was observed, and peaks corresponding to polysulfides Li₂S and LiSx did not exist, unlike the Raman spectrum of the electrode including the KB-S composite. This shows that the electrochemical reversibility of the electrode including S@PTF/PPy is excellent.

FIG. 11C shows SEM images of S@PTF/PPy after 500 cycles of charge and discharge at 3 C for the cell of Example 3-1. Referring to FIG. 11C, it was confirmed that S@PTF/PPy maintained its original core-shell shape without particle collapse even after 500 cycles. Furthermore, as a result of measuring the particle diameter of S@PTF/PPy by analyzing the SEM image, the particle diameter was found to be 313.4 nm, which did not differ from the initial particle diameter before the charge/discharge tests, and the electrode including S@PTF/PPy maintained a constant electrode thickness without cracking or peeling even after 500 cycles. This indicates the structural integrity of the electrode including S@PTF/PPy at the particle and electrode levels.

Table 6 below shows the performance of the lithium-sulfur cell including S@PTF/PPy according to the present disclosure in comparison with that of materials recently reported as cathodes for lithium-sulfur cells.

TABLE 6

| | | | Rate capability | | Long-term stability | |
|---|---|---|---|---|---|---|
| | | | Low-rate | High-rate | | Capacity |
| | | Sulfur | capacity | capacity | C-rate/ | reduction |
| | | content | (mAh g−1) | (mAh g−1) | cycle | rate (%) |
| | Material | (wt %) | (C-rate) | (C-rate) | number | per cycle |
| Cathode | S@PTF/PPY | 80.35 | 1479 | 852 | 3 C/500 | 0.009 |
| active | | | (0.2 C) | (5 C) | 5 C/500 | 0.036 |
| material | S@PVP | 70.4 | 1099 | 674 | 0.5 C/1000 | 0.046 |
| with core- | | | (0.2 C) | (1 C) | | |
| shell | S@N-doped | 65.2 | 1231 | 606 | 2 C/2000 | 0.028 |
| structure | graphene | | (0.1 C) | (5 C) | | |
| | S@MoS2 | 65 | 1660 | 305 | 1 C/1000 | 0.045 |
| | | | (0.1 C) | (5 C) | | |
| | S@MnO2@PPy | 82.5 | 1367 | 1100 | 0.5 C/500 | 0.066 |
| | | | (0.2 C) | (1 C) | | |
| | S@CNT/TiO2 | 75 | 1324 | 597 | 0.5 C/300 | 0.108 |
| | @S-graphene | | (0.2 C) | (5 C) | | |
| Catalyst | S@Fe3—xC@C | 74 | 1265 | 609 | 1 C/1000 | 0.040 |
| sulfur | | | (0.2 C) | (5 C) | | |
| host | S@CoSe2/Co | 80 | 1457 | 688 | 2 C/500 | 0.045 |
| cathode | 304-NC-CNT | | (0.1 C) | (5 C) | | |
| | S@TiSC2 | 74.7 | 1203 | 772 | 1 C/500 | 0.044 |
| | Mxene | | (0.2 C) | (5 C) | | |
| | S@ZnN4-NC | 75.1 | 1229 | 514 | 1 C/500 | 0.033 |
| | | | (0.2 C) | (5 C) | | |
| | S@Ni-MDF- | 70.2 | 1491 | 575 | 3 C/1000 | 0.018 |
| | 1D | | (0.1 C) | (8 C) | | |
| | S@Co4W18- | 70 | 1251 | 644 | 2 C/1000 | 0.015 |
| | rGO | | (0.1 C) | (5 C) | | |
| Modified | BN@CNF/ | 80 | 1244 | 663 | 1 C/800 | 0.046 |
| separator/ | Rgo@Ru | | (0.1 C) | (5 C) | | |
| interlayer | Janus | | | | | |
| | separator | | | | | |
| | CNT@THPP | 70 | 1610 | 734.2 | 5 C/1500 | 0.055 |
| | interlayer | | (0.2 C) | (5 C) | | |
| | Fe/Co—N—C | 70 | 1456 | 740 | 1 C/600 | 0.055 |
| | coated | | (0.1 C) | (5 C) | | |
| | separator | | | | | |

Referring to Table 6 above, the lithium-sulfur cell including S@PTF/PPy as the cathode active material not only exhibited superior performance than state-of-the-art lithium-sulfur cells, but also achieved overwhelming performance compared to cells including existing core-shell type active materials.

Although the present disclosure has been described above by way of limited embodiments, the present disclosure is not limited embodiments. It should be understood that various modifications and changes are possible by those skilled in the art without departing from the technical sprit of the present disclosure and the range of equivalents to the appended claims.

What is claimed is:

1. A multilayer core-shell structure comprising:
a core;
a first shell surrounding the core and comprising an organic linker, which comprises a multifunctional organic compound, and a first polymer; and
a second shell surrounding the first shell and comprising a second polymer,
wherein the first polymer and the organic linker form a network by non-covalent interaction therebetween.

2. The multilayer core-shell structure according to claim 1, wherein the non-covalent interaction is at least one selected from the group consisting of interactions based on hydrogen bonding, van der Waals force, ionic bonding, dipole-dipole interaction, pi-pi interaction, cation-pi interaction, and halogen bonding.

3. The multilayer core-shell structure according to claim 1, wherein the multifunctional organic compound contains at least one functional group selected from the group consisting of imide, urea, amide, carbonyl, carboxy, hydroxy, ether, azoxy, oxadiazole, thiol, thioether, thiourea, thiadiazole, sulfonate, nitro, amine, imine, azine, pyridine, pyrazine, pyrimidine, pyridazine, triazine, tetrazine, pyrazole, imidazole, triazole, tetrazole, phosphate, and halogen.

4. The multilayer core-shell structure according to claim 3, wherein the multifunctional organic compound contains three or more functional groups.

5. The multilayer core-shell structure according to claim 1, wherein the first polymer is a polymer compound containing at least one functional group selected from the group consisting of imide, urea, amide, carbonyl, carboxy, hydroxy, ether, oxadiazole, azoxy, thiol, thioether, thiourea, thiadiazole, sulfonate, nitro, amine, imine, azine, pyridine, pyrazine, pyrimidine, pyridazine, triazine, tetrazine, pyrazole, imidazole, triazole, tetrazole, phosphate, and halogen.

6. The multilayer core-shell structure according to claim 1, wherein the first shell further comprises a single-atom catalyst that coordinates with the organic linker.

7. The multilayer core-shell structure according to claim 6, wherein the single-atom catalyst comprises at least one selected form the group consisting of Be, B, Mg, Al, Si, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, Lu, Ac, Th, U, Np, Pu, Am, and Cm.

8. The multilayer core-shell structure according to claim 1, wherein the core comprises a cathode active material, an anode active material, a drug, a semiconductor, a catalyst material, or a magnetic particle.

9. The multilayer core-shell structure according to claim 1, wherein the second polymer comprises a conductive polymer, a fluorescent polymer, a self-healing polymer, a biocompatible polymer, or a shape memory polymer.

10. A cathode active material for a lithium-sulfur cell comprising the multilayer core-shell structure according to claim 1, wherein the core contains sulfur, and the second polymer comprises a conductive polymer.

11. The cathode active material according to claim 10, wherein the conductive polymer comprises at least one selected from the group consisting of polypyrrole, polyfluorene, polyphenylene, polypyrene, polyazulene, polynaphthalene, polycarbazole, polyindole, polyazepine, polyaniline, polythiophene, poly (3,4-ethylenedioxythiophene), poly (p-phenylene sulfide), polyacetylene, poly (p-phenylene vinylene), poly (3,4-ethylenedioxythiophene)-polystyrene sulfonate(PEDOT-PSS), derivatives thereof, and copolymers thereof.

12. The cathode active material according to claim 10, wherein a content of the core containing sulfur is 70 parts by weight to 95 parts by weight based on 100 parts by weight of the total weight of the multilayer core-shell structure.

13. The cathode active material according to claim 10, wherein the multilayer core-shell structure has an average diameter of 100 nm to 1,000 nm.

14. A method for producing the multilayer core-shell structure according to claim 1, comprising steps of:
mixing a solution containing a first polymer and a solution containing an organic linker comprising a multifunctional organic compound to obtain a solution having dispersed therein a network structure formed by non-covalent interaction between the first polymer and the organic linker;
adding a material for core growth to the solution having dispersed therein the network structure to obtain a core-first shell intermediate; and
forming a second shell comprising a second polymer by adding a monomer for the second polymer to the solution containing the core-first shell intermediate, followed by reaction.

15. The method according to claim 14, further comprising, before the step of forming the second shell, a step of forming a single-atom catalyst, which coordinates with the organic linker, by adding a metal precursor to the solution having the core-first shell intermediate dispersed therein.

16. The method according to claim 14, wherein the solution containing the first polymer and the solution containing the organic linker the comprising multifunctional organic compound are mixed together at a weight ratio of 500:1 to 10:1.
